(19) United States
(12) Patent Application Publication
(10) Pub. No.: US 2013/0142100 A1
(43) Pub. Date: Jun. 6, 2013

(54) METHOD AND APPARATUS FOR DISTRIBUTED RADIO RESOURCE MANAGEMENT FOR INTERCELL INTERFERENCE COORDINATION

(71) Applicants: Sophie Vrzic, Kanata (CA); Chandra Bontu, Kanata (CA); David G. Steer, Kanata (CA)

(72) Inventors: Sophie Vrzic, Kanata (CA); Chandra Bontu, Kanata (CA); David G. Steer, Kanata (CA)

(73) Assignee: RESEARCH IN MOTION LIMITED, Waterloo (CA)

(21) Appl. No.: 13/492,004

(22) Filed: Jun. 8, 2012

(30) Foreign Application Priority Data
Jun. 9, 2011 (CA) PCT/CA2011/000671

(51) Int. Cl. H04W 72/08

(52) U.S. Cl. CPC H04W 72/082
USPC 370/312

(57) ABSTRACT

A method at a user equipment and the user equipment, the method: obtaining an event having event conditions from system information multicasts of a plurality of network nodes; and sending an uplink message to at least one network node for any event whose conditions are satisfied utilizing resources allocated for the event. Also, a method at a network node and the network node, the method multicasting an event having event conditions to a plurality of user equipments; receiving a communication from a user equipment attached to the said network node or any neighbor network nodes, said communication providing an indication that the event conditions are met at the user equipment; compiling statistics, based on the receiving, of network conditions; and performing resource allocation based on the compiled statistics.

### CROSS-REFERENCE TO RELATED APPLICATIONS

The present application claims priority to PCT Application No. PCT/CA2011/000671, having an international filing date of Jun. 9, 2011, the entire contents of which are incorporated herein by reference.

### FIELD OF THE DISCLOSURE

The present disclosure relates to radio resource management for inter-cell interference coordination and in particular to radio resource management for inter-cell interference coordination in heterogeneous networks.

### BACKGROUND

Heterogeneous networks consist of macro cells, pico cells and femto cells, among others, operating on different radio access technologies (RATs), including but not limited to the 3^{rd} Generation Partnership Project-Long Term Evolution (3GPP-LTE) or WiMAX. In such networks, interference coordination becomes more challenging compared with traditional homogenous networks. In particular, heterogeneous networks may be characterized by cells or network nodes of varying capabilities and the number of nodes required to cover the network area may increase. As a result, interference coordination between the neighboring cells becomes more complex. In addition, the presence of multiple radio access technologies may make coordination among network nodes more challenging.

In homogeneous networks, coordination information, such as resource utilization, is sent by each enhanced node B (eNB) or Base Station (BS), hereinafter referred to as a network node, to neighboring network nodes over a wired or wireless inter-node backhaul communication link. The decision on how to distribute power across the available resources or resource blocks (RBs) on the downlink (DL) is made by each network node independently after receiving the information from neighboring nodes. The approach therefore requires several iterations of backhaul messaging between neighboring nodes to stabilize to an optimal operating point.

In heterogeneous networks, a direct communication link may not exist between all networks nodes for exchanging information necessary for inter-cell interference coordination. In particular, some of the network nodes may be deployed by different operators. Further, a direct communication link may not exist where the network nodes support different radio access technologies.

### BRIEF DESCRIPTION OF THE DRAWINGS

The present disclosure will be better understood with reference to the drawings, in which:

FIG. 1 is a simplified topological diagram showing typical deployment of heterogeneous wireless networks comprising different radio access technologies;

FIG. 2 is a simplified topological diagram showing a heterogeneous network in which a user equipment reports to non-serving network nodes;

FIG. 3 shows a diagram for fractional frequency reuse having four zones and three cells;

FIG. 4 is a flow diagram showing the reporting of events based on measured interference power;

FIG. 5 is a flow diagram showing the reporting of events based on transmit power;

FIG. 6 shows an uplink common control channel structure when a user equipment is not uplink synchronized with a target node;

FIG. 7 shows an uplink common control channel structure when a user equipment is uplink synchronized with a target node; and

FIG. 8 is a block diagram of an exemplary user equipment capable of being used with the embodiments of the present disclosure.

### DETAILED DESCRIPTION OF THE DRAWINGS

The present disclosure provides a method at a user equipment comprising: obtaining an event having event conditions from system information multicasts of a plurality of network nodes; and sending an uplink message to at least one network node for any event whose conditions are satisfied utilizing resources allocated for the event.

The present disclosure further provides a user equipment comprising: a processor; and a communications subsystem, wherein the processor and communications subsystem cooperate to: obtain an event having event conditions from system information multicasts of a plurality of network nodes; and send an uplink message to at least one of the network nodes for any event whose conditions are satisfied utilizing resources allocated for the event.

The present disclosure still further provides a method at a network node comprising: multicasting an event having event conditions to a plurality of user equipments; receiving a communication from a user equipment attached to the said network node or any neighbor network nodes, said communication providing an indication that the event conditions are met at the user equipment; compiling statistics, based on the receiving, of network conditions; and performing resource allocation based on the compiled statistics.

The present disclosure still further provides a network node comprising: a processor; and a communications subsystem, wherein the processor and communications subsystem cooperate to: multicast an event having event conditions to a plurality of user equipments; receive a communication from a user equipment, said communication providing an indication that the event conditions are met at the user equipment; compile statistics, based on the receiving, of network conditions; and perform resource allocation based on the compiled statistics.

The present disclosure still further provides a method in a network comprising: multicasting an event from a network node to a plurality of user equipments, the event having event conditions; obtaining the event having event conditions at at least one of the plurality of user equipments; sending an uplink message from the one of the plurality of user equipments for any event whose conditions are satisfied utilizing resources allocated for the event; receiving the uplink message at the network node; compiling statistics, based on the receiving, of network conditions; and performing resource allocation based on the collected statistics.

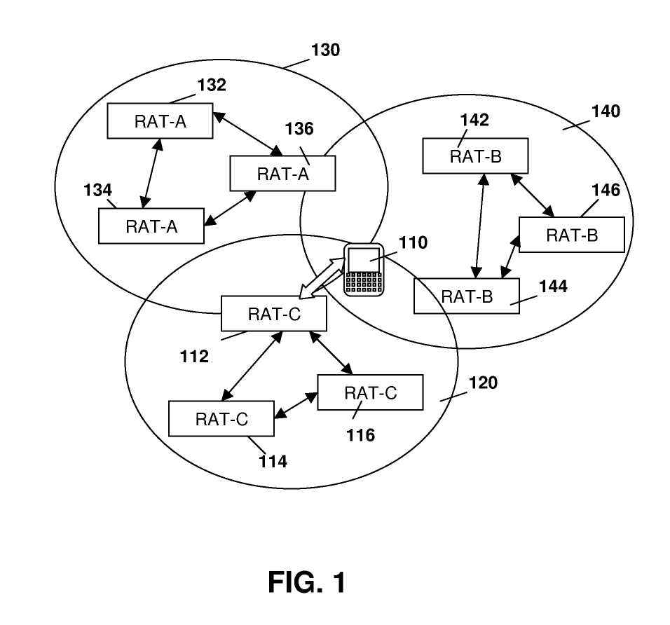

Reference is now made to FIG. 1, which shows a single frequency network deployment scenario where a user equipment (UE) is communicating with its serving node using one radio access technology while other nearby network nodes operating on the same frequency band are using a different radio access technology. In particular, UE 110 is communicating with network node 112 using radio access technology “C”. Network node 112, 114 and 116 belong to a first radio access technology 120. In the example of FIG. 1 this first radio access technology is denoted as RAT-C.

Similarly, a second RAT 130 includes network nodes 132, 134 and 136. In the example of FIG. 1 this is denoted as RAT-A.

A third radio access technology area 140 includes network nodes 142, 144 and 146. In FIG. 1 the third radio access technology is denoted as RAT-B.

In the example of FIG. 1 the network nodes that belong to different radio access technologies may not have a direct communication link between them. Thus, network nodes 112, 114 and 116 may have communication links between them but network node 112 may not have any direct communication link with network 134, for example. In some scenarios, the network nodes 112, 114 and 116 may not have a backhaul communication link among them, even though they operate using the same radio access technology, if each of these nodes belong to different operators.

As indicated above, a network node may be any node within a network capable of providing data to a user equipment and can include a Node B, enhanced Node B, home enhanced Node B (HeNB), base station, relay, among others. Typically, a network node will include at least a processor and communication subsystem to communicate with other network nodes and with user equipments.

In the example of FIG. 1, UE 110 is capable of communicating with multiple radio access technologies.

The example of FIG. 1 may arise when different operators are using shared spectrum or operating different radio access technologies, or when different network nodes from the same network operator and are using shared spectrum using different RATs.

In the example of FIG. 1, the areas with the same RAT may have inter-cell interference coordination (ICIC). For example, in Long Term Evolution (LTE) systems, the coordination involves backhaul messages sent between neighboring eNBs. The messages contain the planned transmit power per resource block (RB). After several iterations of these backhaul messages, the power bandwidth profile typically stabilizes so that high power RBs of neighboring eNBs do not overlap.

In other embodiments, within the same RAT different power bandwidth profiles are fixed and the profile used by each eNB is adapted based on messages from neighboring nodes. This also requires backhaul signalling to inform a neighboring node to adjust its power bandwidth profile.

Thus, the present disclosure provides for distributed or independent radio resource management (RRM) at each network node when a deployed cellular network has at least one of the following:
multiple RATs are operating over the same or overlapping frequency bands;
network nodes and/or some parts of the network are operated by different cellular operators; or
some of the network nodes may not have direct or indirect backhaul communication links between them.

In the present disclosure, at least a subset of the UEs that are operating within each cell are assumed to be capable of communicating with network nodes of different radio access technologies. However, not all UEs are required to be capable of communication with each RAT. Further, the UEs are assumed to be authorized to communicate with the network nodes and are capable of reading broadcast/multicast messages from the RATs in the vicinity.

In accordance with the present disclosure, the UEs can provide information to both the serving node and to neighboring nodes through uplink common control channels (UL CCCH) configured by each network node. The information sent over the UL CCCH of the neighboring node may consist of a collection of statistics from the UEs, and in some embodiments cell edge UEs of the particular cell. The information can then be used, for example, by a target eNB for the purpose of managing over-the-air resources in future resource allocation decisions.

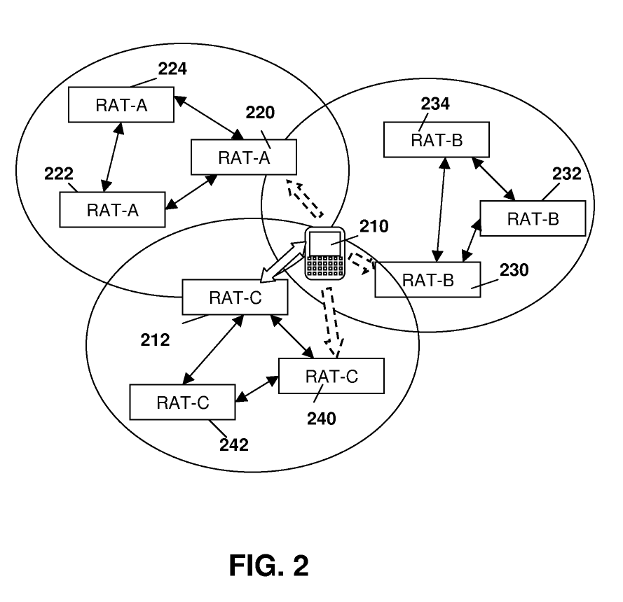

Reference is now made to FIG. 2. In the embodiment of FIG. 2, UE 210 communicates with a network node 212 and network node 212 is the serving network node for UE 210. However, UE 210 is further capable of receiving and decoding information from radio access technologies “A” and “B”, as well as the radio access technology “C” of serving node 212. Thus, UE 210 can receive communications from non-serving network nodes 220 of radio access technology ‘A’ and network node 230 of radio access technology ‘B’, as well as from network node 240 of radio access technology “C”.

Other network nodes such as network node 222 and 224 may have the same radio access technology as network node 220 and be able to communicate with network node 220 over backhaul channels.

Similarly, network nodes 232 and 234 may have the same radio access technology as network node 230 and be able to communicate with network node 220 over backhaul channels.

Similarly, network nodes 242 and 240 may communicate with each other and also with network node 212 over backhaul channels.

FIG. 2 illustrates the UE 210 providing information to non-serving network nodes, which may be operating using different radio access technologies than the serving node, through the use of an UL CCCH configured for each of the non-serving nodes. The nodes may or may not be interfering network nodes in accordance with the present disclosure.

Each network node may have an UL CCCH and this may be RAT specific. The UL CCCH channel descriptor and event triggers may be broadcast/multicast by a network node. A multi-RAT capable UE 210 can decode the RAT specific broadcast/multicast channels and store information about events and uplink CCCH descriptors for each network node, as described in more detail below.

Further, as described in more detail below, a UE 210 may make measurements with respect to the network nodes and check for an event occurrence. The measurements may be RAT specific, event specific or both.

When an event occurs with respect to a network node, the UE may send an event indicator on the uplink CCCH to the node, as described in more detail below.

Thus, for example, referring to FIG. 2, UE 210 is capable of communicating with network nodes of RATs “A”/“B”/“C”. The UE has serving node 212, which supports RAT “C” and may perform event specific measurements with regard to neighboring network nodes. Specific events are advertised by each neighboring node in their respective broadcast/multicast channels. If the RAT measurement meets the criteria defined by the events specified for a particular network node, the UE 210 transmits the UL CCCH to that particular network node.

Thus, the UL CCCH configuration of events can be network node specific and the approach described in the present disclosure can be used for either single RAT or multiple RAT scenarios.

One scenario is where there may be multiple RATs operating in the same band as the case where the allocated band is in shared spectrum. In this case, network nodes can be reconfigurable eNBs, RNs or Home eNBs (HeNBs). The reconfigurable nodes can be assigned dynamic component carriers (DCCs) which can be adapted to operate on any RAT and may use any available channel within the shared spectrum.

In a further embodiment, the shared spectrum can be the licensed spectrum that belongs to a single operator and allocated dynamically to different nodes within the operators network or can be a spectrum that is shared among multiple operators. In either case, the assigned channels may be any RAT and the RAT may change based on demand.

In another scenario, a secondary system may be allocated to operate as an underlay of a primary system. Further, the two systems may use different RATs. In this embodiment, the secondary user shares the same resources as the primary user, but with low transmit power in order to reduce the impact to the primary user. Both the primary user and the secondary user may use the UL CCCH to report any events that occurred, as described below. The events can be designed in order to optimize the performance of the combined primary and secondary usage of the shared resources. For example, the primary user can indicate whether or not there is too much interference or outage caused by the secondary usage and the secondary user may adjust its usage accordingly.

In single RAT cases, the approach described below can be used in heterogeneous networks that consist of eNBs, relay nodes and HeNBs. Since some network nodes may not have a backhaul connection, the method of communicating interference statistics in accordance with the present disclosure may be used. The UL CCCH can be used to provide information for interference coordination in the heterogeneous network.

As will be appreciated by those in the art having regard to the above, the UEs do not need to exactly acquire uplink (UL) transmission timing of non-serving network nodes. The network nodes may broadcast/multicast the UL common control channel (UL CCCH) descriptor and associated event triggers for collecting the statistics. All UEs that can correctly decode the broadcast/multicast message of the non-serving cell may check if any of the defined events occurred. For example, an event may be defined as a condition where the interference level measured at the UE is above a given threshold. If an event occurs then the UE may inform the network nodes.

The UL common control channel is designed to be a low overhead feedback channel. Since a UE may satisfy the events from multi-neighboring nodes, the UE may be required to send information on several UL CCCHs. In order to ensure that the UEs are not required to send this feedback to multiple network nodes during the same sub-frame, the sub-frame which contains the UL common control channel may be different for different cells. One way to accomplish this is to use cell specific sub-frame numbers for the UL common control channel. The control channel configuration will thus be dependent on the unique identifier of the node and hence different and non-overlapping for each cell.

In an orthogonal frequency division multiplexing (OFDM) system, such as LTE, if the UEs have UL synchronization with the target network node then the signaling channel can be allocated as little as one OFDM symbol or part of an OFDM symbol. Otherwise, if no UL synchronization is available then the UL signaling channel requires more resources since a sufficient guard time must be added to account for different arrival times of the OFDM symbols.

The above-described embodiment therefore provides for network nodes publishing events and then collecting event specific statistics from the UEs that detect those events and meet the event criteria. From a UE perspective, the UE can review the specifics of the events that it has received over the broadcast/multicast channel to check if any of these events have occurred. If these events have occurred, the UE sends a message on the UL CCCH of the node whose event has been satisfied. The UL communication can be minimal to indicate merely that an event has occurred. Such signaling may be minimized to reduce overhead for the network and battery resources on the mobile device or UE.

Various examples for such signaling are provided below.

Downlink Distributed Radio Resource Management for ICIC

One example of distributed RRM using the UL CCCH can be for interference mitigation or coordination or adaptive Fractional Frequency Reuse (FFR) on the downlink where both the transmit power and the number of resources used per FFR zone are adapted.

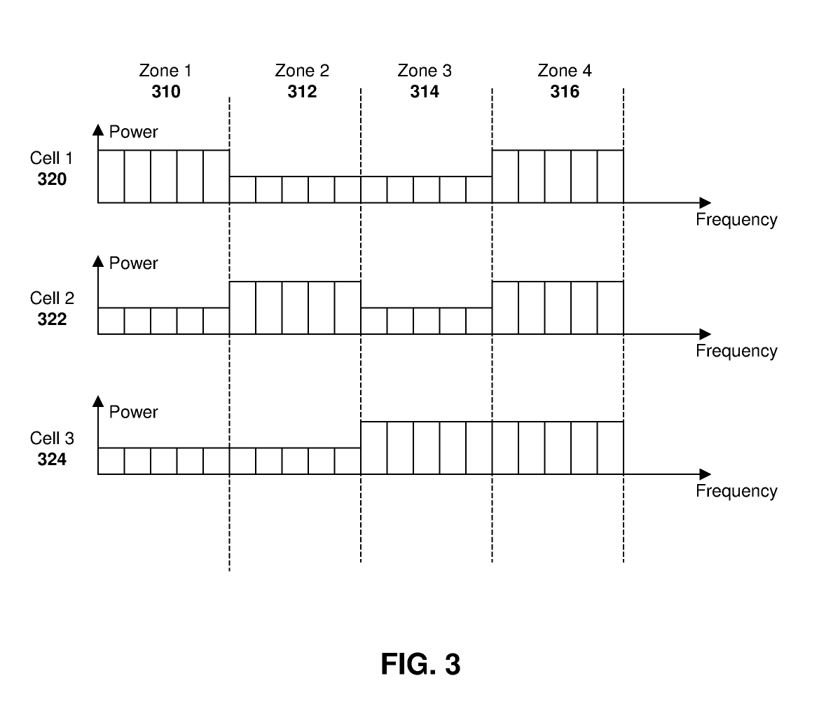

Reference is now made to FIG. 3, which shows an example of an FFR implementation.

As seen in FIG. 3, four frequency zones exist in the three cells in the example. Namely, zone 310, 312, 314 and 316 provided within cells 320, 322 and 324.

Cell one uses a higher power in zone 310. Cell two uses a higher power in zone 312 and cell three uses a higher power in zone 314, as seen in the example of FIG. 3. The lower power used, for example, in zone 310 by cells 322 and 324 provides for lower interference on the cell edge for mobile devices connected with cell 320.

Zone 316 is a high power zone for all cells.

Thus, when FFR is in enabled, neighboring cells use different resources for high power transmission. By using non-overlapping high power zones, neighboring cells have improved coverage to cell edge UEs.

In order to accommodate cell edge UEs, neighboring cells typically reduce their transmit power on the high power zone of the serving cell. Since the number of cell edge UEs and the amount of traffic destined to the cell edge UEs can vary, it may be beneficial to adapt the number of zones used in the FFR region relative to the reuse zone 316. The network node or eNB can determine the appropriate number of resources for the different zones and the maximum transmit power level for each zone by collecting statistics of interference levels or outage levels and the average number of resources required by the cell edge UEs from other cells.

As discussed above, in order to collect statistics, each network node may broadcast/multicast events to be measured. One example is provided below.

In one embodiment, four events, EV1, EV2, EV3 and EV4 may be broadcast/multicast by various network elements and received by a UE. In particular, the events are:

EV1: Lᵢ<Lₘₐₓ; I₁>I_{max,1} and R>Rₘᵢₙ

EV2: Lᵢ<Lₘₐₓ and Rₘᵢₙ<R<R₁

EV3: Lᵢ<Lₘₐₓ and R₁<R<R₂

EV4: Lᵢ<Lₘₐₓ and R>R₂

Where the parameters are as follows: Lᵢ is the path loss to the i^{th} non-serving network node or eNB. Lₘₐₓ is the maximum allowed path loss to a non-serving eNB for evaluating events. Iⱼ is the measured power of interference signal with respect to the serving node on zone j. I_{max,j} is the maximum interference power with respect to the serving node on zone j. R is the average number of resources the UE is assigned to on the downlink. Rⱼ is the threshold on number of resources for zone-j.

Thus, considering event number one above, the condition Lᵢ is less than Lₘₐₓ is used to restrict the collection of statistics to cell edge UEs.

The I₁ being greater than I_{max,1} indicates that the interference with respect to the serving node is greater than the maximum allowed provides for event triggers if interference is greater than the threshold. Further, R being greater than Rₘᵢₙ indicates that the average number of resources that the UE is assigned to is greater than the minimum number of resources threshold. Based on the above, event one will be triggered if the UE is on the cell edge, the interference is greater than the maximum threshold and the number of resources assigned in the downlink to the UE is greater than the minimum.

Similarly, event two may be triggered if Lᵢ is less than Lₘₐₓ and R is less than R₁. Event three is triggered if Lᵢ is less than Lₘₐₓ and R₁ is less than R, which is less than R₂. Event four is triggered if Lᵢ is less than Lₘₐₓ and R is greater than R₂.

The UE receives the broadcast/multicast with all of these events and checks its current measurements against the events and whether or not to send a response to the network node that broadcast/multicast the event.

A plurality of UEs will monitor these events and send feedback to the network node. The network node can use the responses collected from the UEs of a particular cell to adjust the maximum transmit power of each zone. For example, if a large number of UEs indicate that the total interference power for zone j exceeds the threshold for zone j then the network node can reduce the transmit power for that zone.

The network node can have different uplink channels for collecting inter-cell interference coordination statistics from UEs in different nodes.

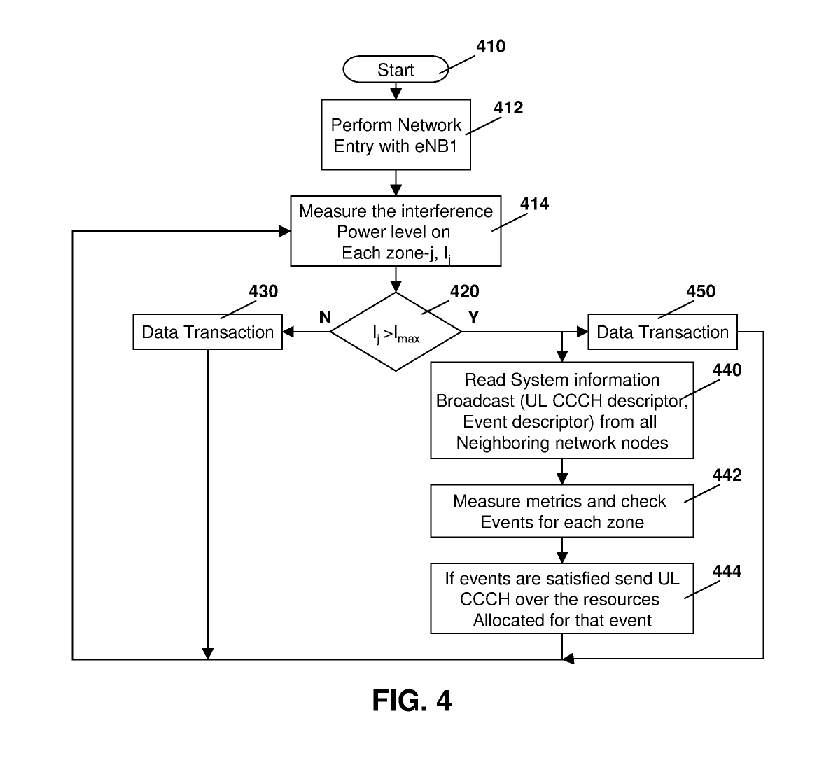

The above is further illustrated with regard to FIG. 4. The process of FIG. 4 starts at block 410 and proceeds to block 412 in which an association is performed with a first network node (e.g. eNB1). During this process of network entry, UE acquires the network node specific parameters by reading the broadcast/multicast messages from the network node. The network node specific parameters, for example, also include Iₘₐₓ, Lₘₐₓ, thresholds of R among other system parameters.

The process then proceeds to block 414 in which the interference power level for each zone is measured.

The process then proceeds to block 420 and checks whether the interference power level for a particular zone is greater than the maximum interference power threshold. If no, the process proceeds to block 430 and performs a regular data transaction.

From block 430 the process proceeds back to block 414 to continue measuring the interference power.

If the interference power of a particular zone exceeds the maximum threshold interference power, the process proceeds from block 420 to block 440. In block 440 the UE reads system information broadcast/multicast from all neighboring network nodes.

Based on the information read at block 440 the process proceeds to block 442 and measures the metrics and checks the events for each zone. Thus, if a first network node indicated that a certain event should be monitored, the UE at block 442 will determine whether or not that event has been triggered.

If the event is triggered the process proceeds to block 444 and sends an UL CCCH over the resources allocated for the event to the network node.

From block 444 the process proceeds back to block 414 and continues to measure interference power.

While performing the processes indicated by blocks 440, 442 and 444, UE may also be actively participating in data transaction as indicated by block 450. In other words the UE performs 440, 442 and 444 without (or with minimum impact) any impact to the ongoing data transaction.

Thus, from FIG. 4, the present disclosure provides for the monitoring of various events as designated by each network node and the provision of information to those network nodes. The network nodes can then use statistics to determine whether enough mobile devices or UEs have reported that a certain event has occurred and adjust power levels or other resources based on such compilation of event reports.

Uplink Distributed RRM for ICIC

Similar statistics can be collected for the purpose of uplink ICIC. In one embodiment of the present disclosure, neighboring nodes may broadcast/multicast the following events to be measured by cell edge UEs of a particular cell.

EV1: Lᵢ<Lₘₐₓ; P₁>P_{max,1} and R>Rₘᵢₙ

EV2: Lᵢ<Lₘₐₓ and Rₘᵢₙ<R<R₁

EV3: Lᵢ<Lₘₐₓ and R₁<R<R₂

EV4: Lᵢ<Lₘₐₓ and R>R₂

The parameters above are defined as Lᵢ is the path loss to the i^{th} serving network node. Lₘₐₓ is the maximum path loss to the non-serving eNB for evaluating events. Pⱼ is the transmit power of zone j. P_{max,j} is the maximum transmit power on zone j. R is the average number of resources the UE is assigned on the downlink and Rⱼ is the number of resources threshold for adjusting zone size.

Thus, the first event is used to control the amount of interference to the UEs that are sending the uplink CCCH from the UEs in the cell receiving the UL CCCH. The event counts the number of cell edges UEs with at least Rₘᵢₙ RBs of data to send that have a transmit power than Pₘₐₓ. If the UE satisfies this event then the UE indicates the event that was triggered in the UL CCCH.

The remaining events are used to control the size of the zone used for cell edge UEs, which is the low interference zone for the neighbor cell. When the neighbor node decodes the UL CCCH it can determine the number of neighboring cell edge UEs that require less than R₁ RBs to transmit on the UL, the number of UEs that require between R₁ and R₂ RBs and the number of UEs that require more than R₂ RBs. With this information the neighbor node can adjust the size of its interference zone in order to accommodate the cell edge traffic of its neighbor.

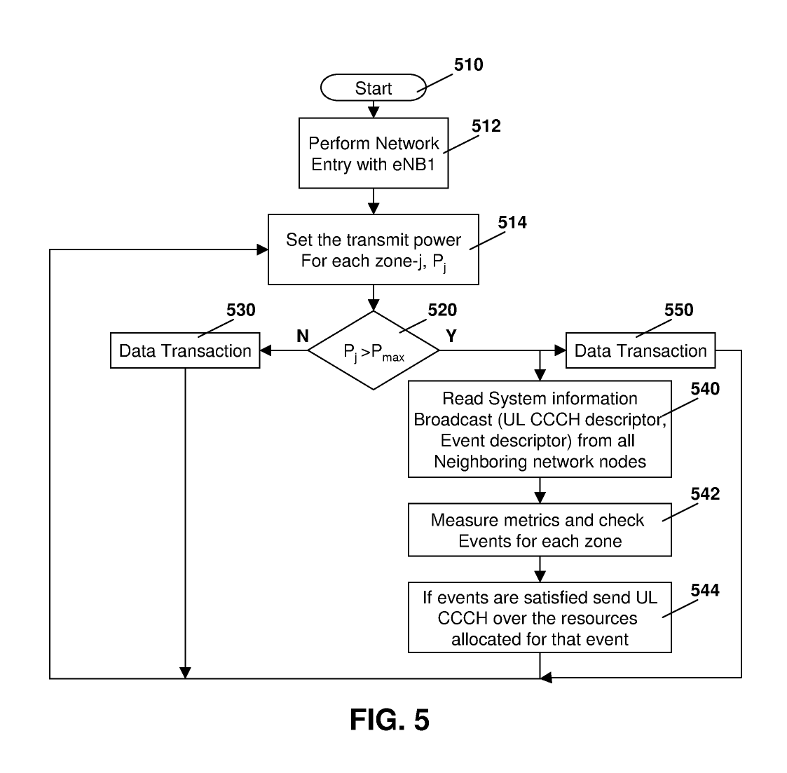

Reference is now made to FIG. 5, which shows UE functionality for uplink ICIC.

The method of FIG. 5 starts at block 510 and proceeds to block 512 in which a network entry is performed with a first network node. During this process of network entry, UE acquires the network node specific parameters by reading the broadcast/multicast messages from the network node. The network node specific parameters, for example, also include Iₘₐₓ, Lₘₐₓ, thresholds of R among other system parameters.

The process then proceeds to block 514 and sets the transmit power for each zone.

The process then proceeds to block 520 and checks whether the power for a zone is greater than a maximum power threshold. If no, the process proceeds to block 530 in which a normal data transaction occurs. From block 530 the process proceeds back to block 514 to set the transmit power for each zone.

If the transmit power is greater than a power threshold the process proceeds to block 540 in which system information broadcasts/multicasts from neighboring nodes are read by the UE. This provides the events that the UE can check.

The process then proceeds to block 542 in which the metrics are measured and checked against the events that were received at block 540.

From block 542 the process proceeds to block 544. In block 544, if any of the events are satisfied then the response is sent on the uplink CCCH over the resources allocated for the event.

From block 544 the process proceeds to block 514 in which the transmit power for each zone is set.

While performing the processes indicated by blocks 540, 542 and 544, UE may also be actively participating in data transaction as indicated by block 550. In other words the UE performs 540, 542 and 544 without (or with minimum impact) any impact to the ongoing data transaction.

Based on the above, the uplink ICIC functionality for the UE may be provided to the network node for each zone.

Common Control Channel Structure

A separate uplink common control channel may be needed for collecting statistics from UEs served by each neighbor cell. Therefore, in one embodiment it is desirable that the uplink feedback channel (UL CCCH) should be a low rate channel that uses minimum resources to maximize overall spectral efficiency. One way to reduce the amount of UL resources is to use the same set of resources for the statistics collected from all UEs that belong to a given neighboring cell. For example, different events can use different spreading codes or other separate resources such as time.

In one embodiment, a feedback from a UE may correspond to one of several possible events. Each event is associated with a unique spreading code. This spreading code is used by all the UEs that satisfy the event and the code is transmitted on the resources allocated for the UL CCCH.

Separate UL CCCH channels can be configured to collect information from UEs that belong to different cells. By decoding using event specific spreading codes the network node can determine the number of UEs that satisfy that particular event.

In an alternative embodiment, each UE served by a specific neighboring node can be assigned a node specific spreading code. If the UE satisfies the conditions of an event, it can transmit its serving node specific spreading code on the resources allocated for the given event. Different resources are used for different events. The network node tries to decode the UL CCCH using each spreading code assigned to all its neighboring nodes. The number of spreading codes that are successfully detected represents the number of UEs that satisfy the conditions of the event associated with the resources used.

As indicated above, the spreading code transmitted by the UE may be network node specific. In an alternative embodiment, the spreading code could also be event and network node specific. In the alternative embodiment, the network node tries to decode the uplink CCCH using each spreading code assigned to all its network nodes and all the events defined. The spreading code may also be UE specific if a sufficient number of codes are available.

If the UE is not uplink synchronized with the neighboring network node that is receiving the uplink CCCH then the uplink CCCH should include sufficient guard time, guard band or both to account for the different arrival times or Doppler shift of the OFDM symbols from different UEs.

Alternatively, the uplink CCCH can be designed assuming that UEs are uplink synchronized with the target node. In this case the resources used for the uplink CCCH channel are smaller, but uplink synchronization results in added complexity for the UE, since the UE must obtain and maintain uplink synchronization with multiple network nodes.

The uplink CCCH may be power controlled by a target node so that the received target signal to interference noise ratio (SINR) is the same for each UE for each event. Alternatively, the UEs can use the same transmit power for the uplink CCCH. In this case, the received SINR will be different for different UEs.

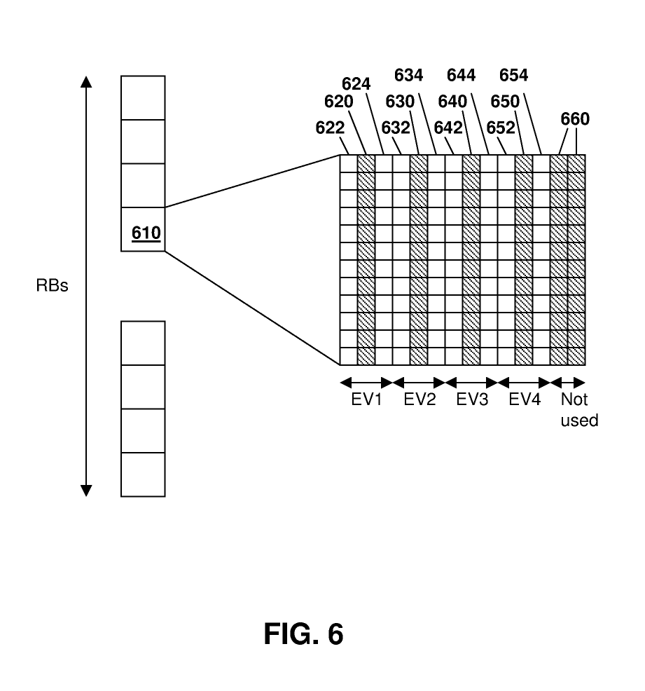

Reference is now made to FIG. 6. FIG. 6 shows the UL CCCH for the unsynchronized case. The embodiment of FIG. 6 shows a guard time of one OFDM symbol. In particular, an OFDM resource block 610 shows a target OFDM symbol for an event 620 surrounded by guard OFDM symbols 622 and 624. In the example of FIG. 6, the OFDM symbol includes symbols for four events. Each includes a target OFDM symbol as well as guard OFDM symbols. In particular, as illustrated in FIG. 6, target OFDM symbol 630 is surrounded by guard symbol 632 and 634. Target OFDM symbol 640 is surrounded by guard symbols 642 and 644. Target OFDM symbol 650 is surrounded by guard symbols 652 and 654. Further, two columns of OFDM symbols are used for interference estimation and are therefore not used for target OFDM signalling for an event. These are shown as symbols 660.

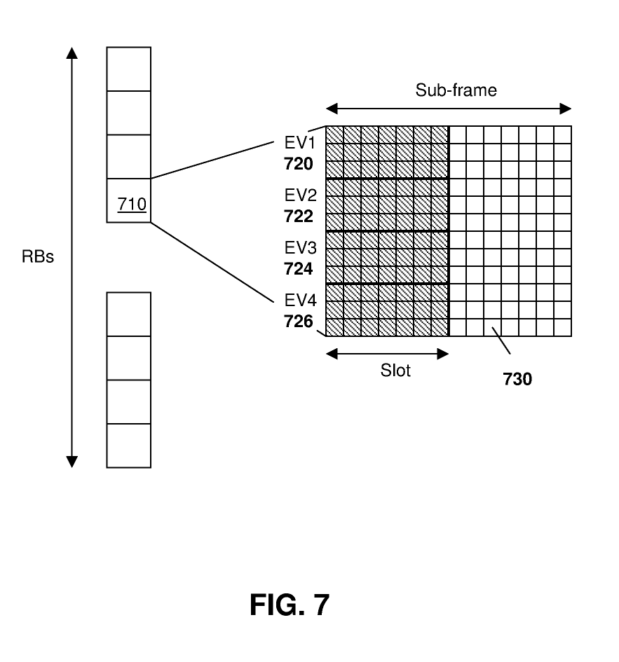

For the synchronized uplink transmission case, reference is now made to FIG. 7. FIG. 7 shows a sub-frame 710 having four events, namely events 720, 722, 724 and 726. Traffic data Symbols may also be communicated and therefore uplink traffic as shown by reference number 730 is provided within the sub-frame 710.

As will be appreciated by those in the art having regard to the present disclosure, the number of resources used for the uplink CCCH is configurable. If the spreading code is UE specific, the length of the spreading sequence may depend on the loading of the cell.

The event configuration for the corresponding node may be indicated to the UEs. This information can be included in a broadcast/multicast message. For example, the radio frame number and the sub-frame number define the uplink common control channel for each node. All the nodes may share a common control configuration with their neighbors.

Each node broadcasts/multicasts its own control channel configuration. In this case, the UEs can decode the broadcast/multicast message of the neighboring nodes with an acceptable success rate. The transmit power of the broadcast/multicast channel can ensure the desired success rate.

If a network operator has multiple carriers, the uplink CCCH channel can be on one of the carriers. The associated events can be related to any of the carriers used by the network operator. Alternatively, each carrier can have its own uplink CCCH channel.

As will be appreciated by those in the art having regard to the present disclosure, in some embodiments security may be provided by having only authorized UEs providing feedback using the uplink CCCH channel. The broadcast/multicast message indicating the events and the corresponding uplink CCCH descriptors may be encrypted by the serving node. The encryption key may be provided to the authenticated mobile devices. The encryption key may be updated periodically. Mobile devices that are unable to decode the broadcast/multicast information would be unable to access the uplink CCCH.

The above therefore provides for the signalling of events to UEs and the provision of information from the UEs to the network nodes if the event is triggered. The size of the message that needs to be sent to the network nodes is minimal and provides an indication that a UE has had that event triggered with minimum use of radio resources.

In alternative embodiments, if the network nodes have the capability of communicating with other network nodes directly, the ICIC procedure described above may be further simplified. Thus, if the neighbor node's UL CCCH resource descriptor and events for each zone are obtained by the UE by reading the neighbor node's broadcast/multicast information then the above embodiments may be utilized. However, if there is backhaul communication between the network nodes, each network node can obtain the ICIC event descriptor and UL CCCH descriptor from the neighboring network nodes and indicate that information in its system broadcast/multicast information. The UE can obtain the necessary information about the neighboring network nodes by reading the system information broadcast/multicast from its serving network node. Further, the UE can perform the event specific measurement and send the UL CCCH to the neighbor network nodes indicating the event occurrence. This alternative has the advantage of the UE not being required to read the broadcast/multicast information channels of all the neighoring cells.

In a further alternative, the UE can inform event occurrence with respect to the neighboring nodes to the serving node. The serving node can then inform this information to the neighbor nodes via the backhaul connection.

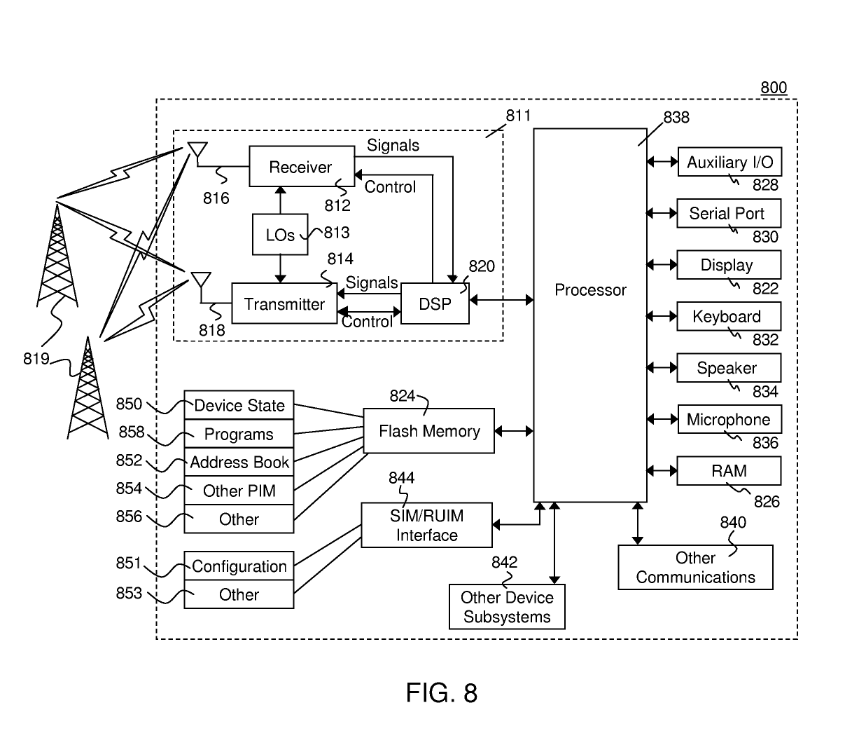

While any UE could be utilized with regard to the above, one example of a UE is provided below with regard to FIG. 8.

UE 800 is typically a two-way wireless communication device having voice and data communication capabilities. UE 800 generally has the capability to communicate with other computer systems on the Internet. Depending on the exact functionality provided, the UE may be referred to as a data messaging device, a two-way pager, a wireless e-mail device, a cellular telephone with data messaging capabilities, a wireless Internet appliance, a wireless device, a user equipment, or a data communication device, as examples.

Where UE 800 is enabled for two-way communication, it will incorporate a communication subsystem 811, including both a receiver 812 and a transmitter 814, as well as associated components such as one or more antenna elements 816 and 818, local oscillators (LOs) 813, and a processing module such as a digital signal processor (DSP) 820. As will be apparent to those skilled in the field of communications, the particular design of the communication subsystem 811 will be dependent upon the communication network in which the device is intended to operate. The UE 800 may be capable of accessing multiple radio access technologies in accordance with the embodiments described above.

Network access requirements will also vary depending upon the type of network 819. In some networks network access is associated with a subscriber or user of UE 800. A UE may require a removable user identity module (RUIM) or a subscriber identity module (SIM) card in order to operate on a network. The SIM/RUIM interface 844 is normally similar to a card-slot into which a SIM/RUIM card can be inserted and ejected. The SIM/RUIM card can have memory and hold many key configurations 851, and other information 853 such as identification, and subscriber related information.

When required network registration or activation procedures have been completed, UE 800 may send and receive communication signals over the network 819. As illustrated in FIG. 8, network 819 can consist of multiple base stations communicating with the UE. For example, in a hybrid CDMA 1x EVDO system, a CDMA base station and an EVDO base station communicate with the mobile station and the UE is connected to both simultaneously. Other examples of network technologies and base stations would be apparent to those in the art.

Signals received by antenna 816 through communication network 819 are input to receiver 812, which may perform such common receiver functions as signal amplification, frequency down conversion, filtering, channel selection and the like. A/D conversion of a received signal allows more complex communication functions such as demodulation and decoding to be performed in the DSP 820. In a similar manner, signals to be transmitted are processed, including modulation and encoding for example, by DSP 820 and input to transmitter 814 for digital to analog conversion, frequency up conversion, filtering, amplification and transmission over the communication network 819 via antenna 818. DSP 820 not only processes communication signals, but also provides for receiver and transmitter control. For example, the gains applied to communication signals in receiver 812 and transmitter 814 may be adaptively controlled through automatic gain control algorithms implemented in DSP 820.

UE 800 generally includes a processor 838 which controls the overall operation of the device. Communication functions, including data and voice communications, are performed through communication subsystem 811. Processor 838 also interacts with further device subsystems such as the display 822, flash memory 824, random access memory (RAM) 826, auxiliary input/output (I/O) subsystems 828, serial port 830, one or more keyboards or keypads 832, speaker 834, microphone 836, other communication subsystem 840 such as a short-range communications subsystem and any other device subsystems generally designated as 842. Serial port 830 could include a USB port or other port known to those in the art.

Some of the subsystems shown in FIG. 8 perform communication-related functions, whereas other subsystems may provide “resident” or on-device functions. Notably, some subsystems, such as keyboard 832 and display 822, for example, may be used for both communication-related functions, such as entering a text message for transmission over a communication network, and device-resident functions such as a calculator or task list.

Operating system software used by the processor 838 may be stored in a persistent store such as flash memory 824, which may instead be a read-only memory (ROM) or similar storage element (not shown). Those skilled in the art will appreciate that the operating system, specific device applications, or parts thereof, may be temporarily loaded into a volatile memory such as RAM 826. Received communication signals may also be stored in RAM 826.

As shown, flash memory 824 can be segregated into different areas for both computer programs 858 and program data storage 850, 852, 854 and 856. These different storage types indicate that each program can allocate a portion of flash memory 824 for their own data storage requirements. Processor 838, in addition to its operating system functions, may enable execution of software applications on the UE. A predetermined set of applications that control basic operations, including at least data and voice communication applications for example, will normally be installed on UE 800 during manufacturing. Other applications could be installed subsequently or dynamically.

Applications and software may be stored on any computer readable storage medium. The computer readable storage medium may be a tangible or in transitory/non-transitory medium such as optical (e.g., CD, DVD, etc.), magnetic (e.g., tape or disk) or other memory known in the art.

One software application may be a personal information manager (PIM) application having the ability to organize and manage data items relating to the user of the UE such as, but not limited to, e-mail, calendar events, voice mails, appointments, and task items. Naturally, one or more memory stores would be available on the UE to facilitate storage of PIM data items. Such PIM application may have the ability to send and receive data items, via the wireless network 819. In one embodiment, the PIM data items are seamlessly integrated, synchronized and updated, via the wireless network 819, with the UE user's corresponding data items stored or associated with a host computer system. Further applications may also be loaded onto the UE 800 through the network 819, an auxiliary I/O subsystem 828, serial port 830, short-range communications subsystem 840 or any other suitable subsystem 842, and installed by a user in the RAM 826 or a non-volatile store (not shown) for execution by the processor 838. Such flexibility in application installation increases the functionality of the device and may provide enhanced on-device functions, communication-related functions, or both. For example, secure communication applications may enable electronic commerce functions and other such financial transactions to be performed using the UE 800.

In a data communication mode, a received signal such as a text message or web page download will be processed by the communication subsystem 811 and input to the processor 838, which may further process the received signal for output to the display 822, or alternatively to an auxiliary I/O device 828.

A user of UE 800 may also compose data items such as email messages for example, using the keyboard 832, which may be a complete alphanumeric keyboard or telephone-type keypad, among others, in conjunction with the display 822 and possibly an auxiliary I/O device 828. Such composed items may then be transmitted over a communication network through the communication subsystem 811.

For voice communications, overall operation of UE 800 is similar, except that received signals would typically be output to a speaker 834 and signals for transmission would be generated by a microphone 836. Alternative voice or audio I/O subsystems, such as a voice message recording subsystem, may also be implemented on UE 800. Although voice or audio signal output is preferably accomplished primarily through the speaker 834, display 822 may also be used to provide an indication of the identity of a calling party, the duration of a voice call, or other voice call related information for example.

Serial port 830 in FIG. 8 would normally be implemented in a personal digital assistant (PDA)-type UE for which synchronization with a user's desktop computer (not shown) may be desirable, but is an optional device component. Such a port 830 would enable a user to set preferences through an external device or software application and would extend the capabilities of UE 800 by providing for information or software downloads to UE 800 other than through a wireless communication network. The alternate download path may for example be used to load an encryption key onto the device through a direct and thus reliable and trusted connection to thereby enable secure device communication. As will be appreciated by those skilled in the art, serial port 830 can further be used to connect the UE to a computer to act as a modem.

Other communications subsystems 840, such as a short-range communications subsystem, is a further optional component which may provide for communication between UE 800 and different systems or devices, which need not necessarily be similar devices. For example, the subsystem 840 may include an infrared device and associated circuits and components or a Bluetooth™ communication module to provide for communication with similarly enabled systems and devices.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

1. A method at a user equipment comprising:
obtaining an event having event conditions from system information multicasts of a plurality of network nodes; and
sending an uplink message to at least one network node for any event whose conditions are satisfied utilizing resources allocated for the event.

2. The method of claim 1, wherein the system information multicasts include an uplink common control channel descriptor and event descriptor.

3. The method of claim 1, wherein the obtaining occurs after a received signal quality from the at least one network node meets a predefined criteria.

4. The method of claim 3, wherein the predefined criteria are obtained by reading a broadcast message from the at least one network node.

5. The method of claim 3, wherein the predefined criteria includes a threshold on total power of interfering signals.

6. The method of claim 3, wherein the predefined criteria includes a threshold on received power from a serving cell for the user equipment.

7. The method of claim 1, wherein the multicast message is encrypted such that the user equipment can decrypt the message only if the user equipment is authorized.

8. The method of claim 1, wherein the sending utilizes an uplink common control channel for a particular network node.

9. The method of claim 1, wherein the sending utilizes a spreading code unique for the event.

10. The method of claim 9, wherein the spreading code is unique for a network node

11. The method of claim 1, wherein the sending utilizes a separate uplink common control channel for user equipments belonging to different cells.

12. A user equipment comprising:
a processor; and
a communications subsystem,
wherein the processor and communications subsystem cooperate to:
obtain an event having event conditions from system information multicasts of a plurality of network nodes; and
send an uplink message to at least one of the network nodes for any event whose conditions are satisfied utilizing resources allocated for the event.

13. A method at a network node comprising:
multicasting an event having event conditions to a plurality of user equipments;
receiving a communication from a user equipment attached to the said network node or any neighbor network nodes, said communication providing an indication that the event conditions are met at the user equipment;
compiling statistics, based on the receiving, of network conditions; and
performing resource allocation based on the compiled statistics.

14. The method of claim 13, wherein the multicasting includes an uplink common control channel descriptor and event descriptor.

15. The method of claim 13, wherein the multicast message is encrypted such that only authorized user equipment can decrypt the multicast message.

16. The method of claim 13, wherein the receiving utilizes an uplink common control channel for the particular network node.

17. The method of claim 13, wherein the receiving utilizes a spreading code unique for the event.

18. The method of claim 17, wherein the spreading code is unique for the network node

19. The method of claim 13, wherein the receiving utilizes a separate uplink common control channel for user equipments belonging to different cells.

20. The method of claim 13, wherein all communications are sent utilizing a predetermined transmit power level, and wherein the receiving includes a predefined target signal to interference noise ratio (“SINR”) at the network node.
